(19) United States
(12) Patent Application Publication
(10) Pub. No.: US 2018/0113605 A1
(43) Pub. Date: Apr. 26, 2018

(54) MOBILE TERMINAL AND METHOD FOR CONTROLLING MOBILE TERMINAL

(71) Applicant: BOE TECHNOLOGY GROUP CO., LTD., Beijing (CN)

(72) Inventor: Chunyan JI, Beijing (CN)

(73) Assignee: BOE TECHNOLOGY GROUP CO., LTD., Beijing (CN)

(21) Appl. No.: 15/327,567

(22) PCT Filed: Jul. 5, 2016
(86) PCT No.: PCT/CN2016/088573

§ 371 Date: Jan. 19, 2017

(30) Foreign Application Priority Data
Jul. 7, 2015 (CN) 201510393732.6

(51) Int. Cl. G06F 3/0488; H04M 1/725; G06F 3/0484; G06K 9/00; G06F 3/01

(52) U.S. Cl. CPC G06F 3/04883; H04M 1/7258; H04M 1/72569; H04M 1/72577; G06K 9/0002; G06F 3/016; G06F 3/04847

(57) ABSTRACT

A mobile terminal and a method for controlling a mobile terminal are provided. The mobile terminal includes a terminal body, a control module and a touch mechanism. A surface of the terminal body includes a touch region, the touch mechanism is arranged in a space extending into the terminal body from the surface thereof, and a perpendicular projection of the touch mechanism onto the surface of the terminal body is within the touch region. The touch mechanism includes a touch identification module used to detect a gesture operation performed by a user onto the touch region. The control module is used to determine a button operation command based on the gesture operation and control the terminal body to execute the button operation command.

### CROSS-REFERENCE TO RELATED APPLICATION

This application claims a priority to Chinese Patent Application No. 201510393732.6 filed on Jul. 7, 2015, the disclosure of which is incorporated in its entirety by reference herein.

### TECHNICAL FIELD

The present disclosure relates to the field of communications, and in particular to a mobile terminal and a method for controlling a mobile terminal.

### BACKGROUND

In recent years, the smart phone has been widely applied along with the rapid development of the communications technology. The smart phone has made the daily life more convenient.

The smart phone in the related technology is provided with, for example, a volume button and a power button by which a user may control the smart phone. For example, the user may adjust the volume of the smart phone through the volume button, and may power on or off the smart phone through the power button.

In the related technology, the volume button, the power button and other buttons of the smart phone are all physical buttons protruding from the surface of the frame of the smart phone; therefore, the appearance of the smart phone is adversely affected.

### SUMMARY

In order to make the appearance of the mobile terminal more nice-looking, a mobile terminal and a method for controlling a mobile terminal are provided.

A mobile terminal is provided in some embodiments, including:

a terminal body, a control module and a touch mechanism, where

a surface of the terminal body includes a touch region, the touch mechanism is arranged in a space extending into the terminal body from the surface of the terminal body, and a perpendicular projection of the touch mechanism onto the surface of the terminal body is within the touch region;

the touch mechanism includes a touch identification module configured to detect a gesture operation performed by a user onto the touch region; and

the control module is configured to determine a button operation command based on the gesture operation detected by the touch identification module and control the terminal body to execute the button operation command.

Optionally, the control module is configured to acquire a current status of the terminal body, and determine the button operation command based on the gesture operation detected by the touch identification module and the current status of the terminal body; or the control module is configured to determine a finger with which the user touches the touch region of the surface of the terminal body, and determine the button operation command based on the determined finger and the gesture operation detected by the touch identification module.

Optionally, the control module is configured to determine that the button operation command is a power off command in the case that the current status of the terminal body is a power-on operating status and the gesture operation is a predetermined first gesture operation, or determine that the button operation command is a screen locking command in the case that the current status of the terminal body is the power-on operating status and the gesture operation is a predetermined second gesture operation, where the predetermined first gesture operation is different from the predetermined second gesture operation. The control module is further configured to determine that the button operation command is a power on command in the case that the current status of the terminal body is a power-off status and the gesture operation is a predetermined third gesture operation.

Optionally, the touch identification module is further configured to acquire a first fingerprint of the finger of the user. The control module is further configured to compare the first fingerprint with second fingerprints in a predetermined fingerprint set in the case that the button operation command is the power on command, and control the terminal body to execute the power on command in the case that the predetermined fingerprint set comprises one second fingerprint which is identical to the first fingerprint.

Optionally, a color of the touch region of the surface of the terminal body is identical to a color of the surface of the terminal body at regions adjacent to the touch region.

Optionally, the touch mechanism further includes a feedback module. The control module is further configured to control the feedback module to shake in the case that the touch identification module detects that a finger of the user touches the touch region.

Optionally, the touch mechanism further includes a pressure sensing module configured to acquire a pressure applied onto the touch region by the finger of the user. The control module is further configured to determine a power of the feedback module based on the pressure acquired by the pressure sensing module and control the feedback module to shake based on the power.

Optionally, the touch identification module is arranged at an outermost layer of the touch mechanism, and a perpendicular projection of the touch identification module onto the surface of the terminal body coincides with the entire touch region.

Optionally, the mobile terminal further includes a voltage converting module and an electricity-storage module. The voltage converting module is configured to receive alternating voltages generated by functional modules at the touch region when the finger of the user touches the touch region, convert the alternating voltages into direct voltages having amplitudes within a predetermined range, and store the direct voltages into the electricity-storage module.

Optionally, the touch region is located at a lateral side or a back of the terminal body.

Optionally, the touch region is located at the lateral side of the terminal body and is strip-like. Or, the touch region is located at the back of the terminal body and is straight strip-like, arc or triangular.

A method for controlling a mobile terminal is provided in some embodiments, including steps of:

detecting a gesture operation performed by a finger of a user onto a touch region of a mobile terminal;

determining a button operation command based on the detected gesture operation; and

controlling the mobile terminal to execute the button operation command.

Optionally, the step of determining the button operation command based on the detected gesture operation includes:

acquiring a current status of the mobile terminal, and determining the button operation command based on the detected gesture operation and the acquired current status of the mobile terminal; or

determining the finger with which the user touches the touch region, and determining the button operation command based on the determined finger and the detected gesture operation.

Optionally, the step of determining the button operation command based on the detected gesture operation and the acquired current status of the mobile terminal further includes:

determining that the button operation command is a power off command in the case that the current status of the mobile terminal is a power-on operating status and the detected gesture operation is a predetermined first gesture operation, or determining that the button operation command is a screen locking command in the case that the current status of the mobile terminal is the power-on operating status and the detected gesture operation is a predetermined second gesture operation, wherein the predetermined first gesture operation is different from the predetermined second gesture operation; and

determining that the button operation command is a power on command in the case that the current status of the mobile terminal is a power-off status and the detected gesture operation is a predetermined third gesture operation.

Optionally, the method further includes:

acquiring a first fingerprint of the finger of the user;

where the step of controlling the mobile terminal to execute the button operation command includes:

comparing the first fingerprint with second fingerprints in a predetermined fingerprint set in the case that the button operation command is determined to be the power on command; and

controlling the mobile terminal to execute the power on command in the case that the predetermined fingerprint set comprises one second fingerprint which is identical to the first fingerprint.

Optionally, subsequent to the step of detecting the gesture operation performed by the finger of the user onto the touch region of the mobile terminal, the method further includes:

controlling a feedback module arranged at the touch region to shake.

Optionally, prior to the step of detecting the gesture operation performed by the finger of the user onto the touch region of the mobile terminal, the method further includes:

acquiring a pressure applied onto the touch region by the finger of the user;

determining a power of the feedback module based on the acquired pressure; and

controlling the feedback module to shake based on the determined power.

According to the embodiments of the present disclosure, the touch mechanism is arranged in the space extending into the terminal body from the surface thereof, it is able to detect the gesture operation of the user performed onto the touch region, and the control module may determine the button operation command based on the gesture operation and control the terminal body to execute the button operation command; therefore, physical buttons protruding from the surface of the terminal body can be replaced by the touch mechanism, thereby making the appearance of the mobile terminal more nice-looking.

### BRIEF DESCRIPTION OF THE DRAWINGS

FIG. 1 is a schematic view of a mobile terminal in some embodiments of the present disclosure;

FIG. 2 is a schematic structural view of a mobile terminal in some embodiments of the present disclosure;

FIG. 3 is a schematic structural view of a mobile terminal in some embodiments of the present disclosure;

FIG. 4 is a schematic structural view of a mobile terminal in some embodiments of the present disclosure;

FIG. 5 is a schematic view showing an arrangement of a touch identification module, a feedback module and a pressure sensing module in some embodiments of the present disclosure;

FIG. 6 is a schematic view showing an arrangement of a touch identification module, a feedback module and a pressure sensing module in some embodiments of the present disclosure;

FIG. 7 is a schematic view showing an arrangement of a feedback module and a pressure sensing module in some embodiments of the present disclosure;

FIG. 8 is a schematic structural view of a mobile terminal in some embodiments of the present disclosure;

FIG. 9 is a schematic view of a lateral side of a mobile terminal in some embodiments of the present disclosure;

FIG. 10 is a schematic view of a back of a mobile terminal in some embodiments of the present disclosure; and

FIG. 11 is a flow chart of a method for controlling a mobile terminal in some embodiments of the present disclosure.

### DETAILED DESCRIPTION

In order to make the objects, the technical solutions of the present disclosure more apparent, the present disclosure will be described hereinafter in detail in conjunction with the drawings.

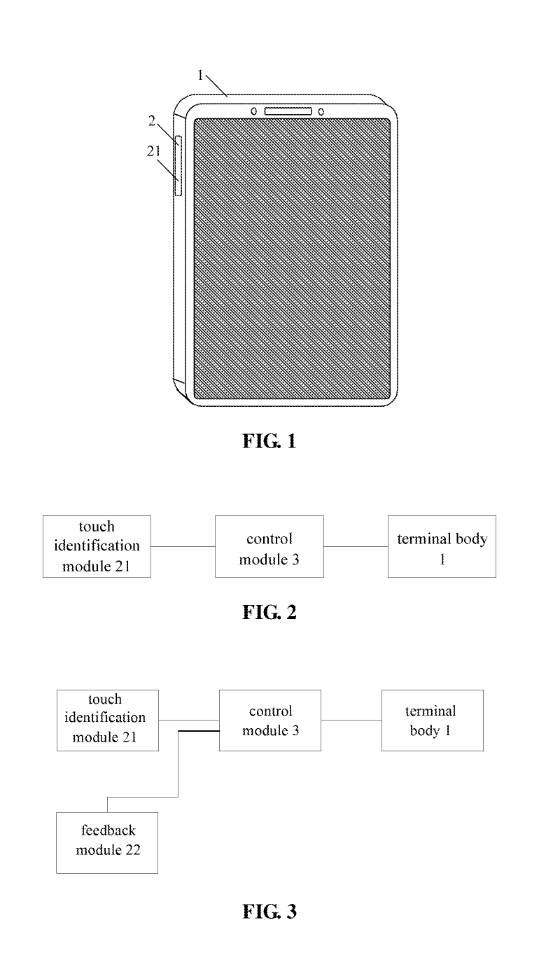

Referring to FIG. 1, a mobile terminal is provided in some embodiments of the present disclosure, including: a terminal body 1, a control module (not shown in FIG. 1) and a touch mechanism. A surface of the terminal body 1 includes a touch region 2. The touch mechanism is arranged in a space extending into the terminal body 1 from the surface thereof. A perpendicular projection of the touch mechanism onto the surface of the terminal body 1 is within the touch region 2. The touch mechanism includes a touch identification module 2. The touch region 2 is a two-dimensional planar region.

The touch identification module 21 is used to detect a gesture operation performed by a user onto the touch region 2.

The control module is used to determine a button operation command based on the gesture operation detected by the touch identification module 21 and control the terminal body 1 to execute the button operation command.

The touch mechanism is arranged in the space extending into the terminal body 1 from the surface thereof, it is able to detect the gesture operation of the user performed onto the touch region 2, and the control module may determine the button operation command based on the gesture operation and control the terminal body 1 to execute the button operation command; therefore, physical buttons protruding from the surface of the terminal body 1 can be replaced by the touch mechanism, which makes the appearance of the mobile terminal more nice-looking.

Referring to FIG. 2, the control module 3 is electrically connected to the touch identification module 21 and the terminal body 1, and the control module 3 may determine the button operation command in the following two ways.

According to a first way of determining the button operation command, the control module 3 acquires a current status of the terminal body 1, and determines the button operation command based on the gesture operation detected by the touch identification module 21 and the current status of the terminal body 1.

To be specific, when the control module 3 acquires that the current status of the terminal body 1 is a power-on operating status, the control module 3 may determine that the button operation command is a power off command in the case that the gesture operation detected by the touch identification module 21 is a predetermined first gesture operation, or may determine that the button operation command is a screen locking command in the case that the gesture operation detected by the touch identification module 21 is a predetermined second gesture operation. The predetermined first gesture operation is different from the predetermined second gesture operation. When the control module 3 acquires that the current status of the terminal body 1 is a power-off status, the control module 3 may determine that the button operation command is a power on command in the case that the gesture operation detected by the touch identification module 21 is a predetermined third gesture operation, where the predetermined first gesture operation may be different from or identical to the predetermined third gesture operation.

Optionally, the touch identification module 21 is further used to acquire a first fingerprint of a finger the user, and the control module 3 is further used to compare the first fingerprint with second fingerprints in a predetermined fingerprint set in the case that the button operation command is the power on command, and send the power on command to the terminal body 1 in the case that the predetermined fingerprint set includes the second fingerprint which is identical to the first fingerprint. The predetermined fingerprint set includes the second fingerprint of each finger of a user corresponding to the mobile terminal.

The control module 3 may acquire the first fingerprint of the finger of the user, and the user is a valid user corresponding to the mobile terminal, i.e., the user is the owner of the mobile terminal, in the case that the predetermined fingerprint set includes one second fingerprint which is identical to the first fingerprint, and then the control module 3 sends the power on command to the terminal body 1 to control the terminal body 1 to power on the mobile terminal.

The predetermined first gesture operation may be sliding upward, sliding downward, sliding clockwise or sliding anticlockwise. The predetermined second gesture operation may be sliding upward, sliding downward, sliding clockwise or sliding anticlockwise. The predetermined third gesture operation may be sliding upward, sliding downward, sliding clockwise or sliding anticlockwise.

For example, when the control module 3 acquires that the current status of the terminal body 1 is the power-on operating status, the control module 3 determines that the button operation command is the power off command in the case that the gesture operation is sliding upward and the predetermined first gesture operation is sliding upward, or determines that the button operation command is the screen locking command in the case that the gesture operation is sliding downward and the predetermined second gesture operation is sliding downward. When the control module 3 acquires that the current status of the terminal body 1 is the power-off status, the control module 3 determines that the button operation command is the power on command in the case that the gesture operation is sliding upward and the predetermined third gesture operation is sliding upward.

According to a second way of determining the button operation command, the control module 3 determines a finger with which a user touches the touch region 2, and then determines the button operation command based on the determined finger and the gesture operation detected by the touch identification module 21.

For example, the button operation command may be predefined to be a paging up or down command when a first finger slides. In other words, when the user uses the first finger to touch the touch region 2 of the surface of the terminal body 1 and the gesture operation is a sliding operation, the control module 3 may determine that the button operation command is the page up or down command. The gesture operation of sliding the first finger upward may correspond to a page up command, and the gesture operation of sliding the first finger downward may correspond to a page down command.

The button operation command may be predefined to be a fast forward or rewind command when a second finger slides. In other words, when the user uses the second finger to touch the touch region 2 of the surface of the terminal body 1 and the gesture operation is a sliding operation, the control module 3 may determine that the button operation command is the fast forward or rewind command. The gesture operation of sliding the second finger upward may correspond to a fast forward command, and the gesture operation of sliding the second finger downward may correspond to a fast rewind command.

The button operation command may be predefined to be a volume adjusting command when a third finger slides. In other words, when the user uses the third finger to touch the touch region 2 of the surface of the terminal body 1 and the gesture operation is a sliding operation, the control module 3 may determine that the button operation command is the volume adjusting command. The gesture operation of sliding the third finger upward may correspond to a volume turning up command, and the gesture operation of sliding the third finger downward may correspond to a volume turning down command.

The first, second and third fingers are different fingers. For example, the first finger may be a forefinger, the second finger may be a midfinger and the third finger may be a ring finger.

Optionally, the step of determining, by the control module 3, a finger with which a user touches the touch region 2 of the surface of the terminal body 1 may include: activating, by the control module 3, the touch identification module 21 to acquire a first fingerprint of the finger with which the user touches the touch region 2 of the surface of the terminal body 1; comparing the first fingerprint with each second fingerprint in a predetermined fingerprint set to obtain the second fingerprint identical to the first fingerprint, where the fingerprint set includes the second fingerprints of all the fingers of a user corresponding to the mobile terminal; and determining the finger corresponding to the obtained second fingerprint to be the finger with which the user touches the touch region 2.

The second fingerprints of respective fingers of the use corresponding to the mobile terminal are prestored to form the fingerprint set. For example, the second fingerprints of the thumb, the forefinger, the midfinger, the ring finger and the little finger are prestored to form the fingerprint set.

Optionally, a color of the touch region 2 of the surface of the terminal body 1 is identical to a color of the surface of the terminal body 1 at regions adjacent to the touch region 2.

In other words, the touch region 2 of the terminal body 1 has a color identical to the regions surrounding the touch region 2. The touch region 2 has a color identical to the surrounding regions, so a user other than the user corresponding to the mobile terminal, when obtaining the mobile terminal, cannot find the accurate position of the touch region 2, and consequently, the user can not power on the mobile terminal, thereby improving the security and privacy of the mobile terminal.

In some embodiments of the present disclosure, the touch region 2 may be at any position of the surface of the terminal body 1. Although the touch region 2 has a color identical to the surrounding regions, the user corresponding to the mobile terminal knows the position of the touch region 2.

In some embodiments of the present disclosure, the touch identification module 21 is a planar structure, and a perpendicular projection of the touch identification module 21 onto the surface of the terminal body 1 coincides with the entire touch region 2. Optionally, the touch identification module 21 includes at least one sliding fingerprint identification sensor. A planar structure is formed by the at least one sliding fingerprint identification sensor, and a perpendicular projection of such planar structure onto the surface of the terminal body 1 coincides with the entire touch region 2. As such, the touch identification module 21 is formed.

Furthermore, referring to FIG. 3, the touch mechanism further includes a feedback module 22 which is electrically connected to the control module 3.

The control module 3 is further used to control the feedback module 22 to shake in the case that the touch identification module 21 detects that a finger of the user touches the touch region 2 of the surface of the terminal body 1.

Since the touch region 2 has a color identical to the surrounding regions, the user may slide beyond the touch region 2. In view of this, when the user touches the touch region, touch operation of the user can be guided based on response from the shaking feedback module 22, so as to prevent the user from sliding beyond the touch region 2.

Optionally, in some embodiments of the present disclosure, the feedback module 22 may be a planar structure and a perpendicular projection of the feedback module 22 onto the surface of the terminal body 1 coincides with the entire touch region 2. Optionally, the feedback module 22 includes at least one piezoelectric actuator. A planar structure is formed by the at least one piezoelectric actuator, and a projection of such planar structure onto the surface of the terminal body 1 coincides with the entire touch region 2. As such, the feedback module 22 is formed.

Optionally, in order to guarantee the touch identification module 21 to detect the gesture operation of the user accurately, the touch identification module 21 may be arranged at an outermost layer of the touch mechanism, and the feedback module 22 may be arranged below the touch identification module 21.

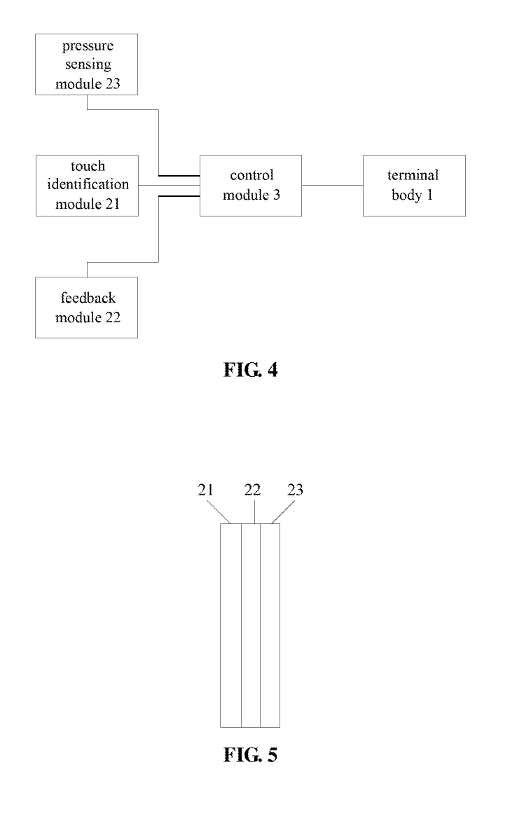

Optionally, referring to FIG. 4, the touch mechanism further includes a pressure sensing module 23 electrically connected to the control module 3.

The pressure sensing module 23 is used to acquire a pressure applied onto the touch region 2 by the finger of the user.

The control module 3 is further used to determine a power of the feedback module 22 based on the pressure acquired by the pressure sensing module 23 and control the feedback module 22 to shake based on the determined power.

A shaking degree of the feedback module 22 may be adjusted based on the pressure applied onto the touch region 2 by the user. To be specific, the larger the pressure is applied, the larger a reacting force will be generated, such that the user may be aware of the degree of the applied pressure, thereby improving the man-machine interaction experience.

Optionally, in some embodiments of the present disclosure, the pressure sensing module 23 may have a planar structure and a perpendicular projection of the pressure sensing module 23 onto the surface of the terminal body 1 coincides with the entire touch region 2. Optionally, the pressure sensing module 23 includes at least one pressure sensing resistor. A planar structure is formed by the at least one pressure sensing resistor, and a projection of such planar structure onto the surface of the terminal body 1 coincides with the entire touch region 2. As such, the pressure sensing module 23 is formed.

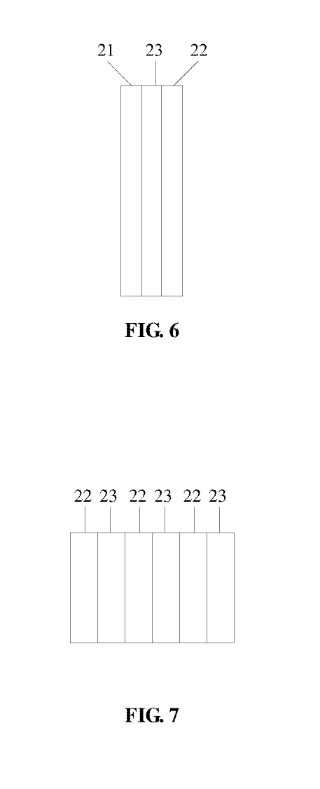

Optionally, referring to FIG. 5, the pressure sensing module 23 may be arranged at an innermost layer of the touch mechanism, i.e., at the touch region 2, the touch mechanism includes, from the outermost layer to the innermost layer thereof, the touch identification module 21, the feedback module 22 and the pressure sensing module 23 that are successively arranged in the order as listed above. Alternatively, referring to FIG. 6, the pressure sensing module 23 may be arranged between the touch identification module 21 and the feedback module 22, i.e., at the touch region 2, the touch mechanism includes, from the outermost layer to the innermost layer thereof, the touch identification module 21, the pressure sensing module 23 and the feedback module 22 in the order as listed above.

Optionally, referring to FIG. 7, the feedback module 22 and the pressure sensing module 23 may be formed as one planar structure. In this plane structure, feedback modules 22 and pressure sensing modules 23 are arranged alternately. As such, the touch mechanism includes two layers, where an outer layer is the touch identification module 21, and an inner layer is the planar structure consisting of the feedback modules 22 and the pressure sensing modules 23 arranged alternately, thereby reducing the thickness of the touch mechanism.

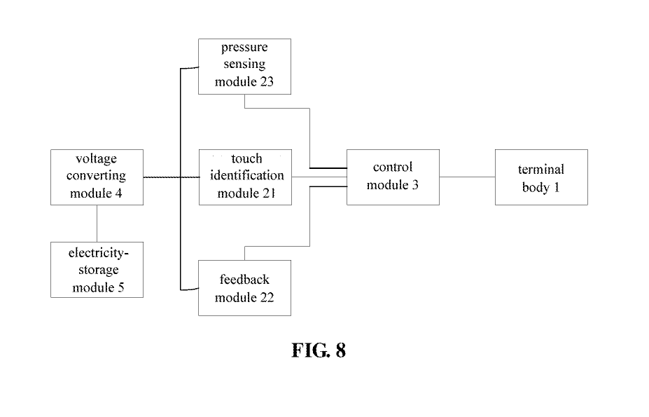

Furthermore, referring to FIG. 8, the mobile terminal further includes a voltage converting module 4 and an electricity-storage module 5.

The voltage converting module 4 is used to receive alternating voltages generated by functional modules at the touch region 2 when the finger of the user touches the touch region 2, convert the alternating voltages into direct voltages having amplitudes within a predetermined range, and store the direct voltages into the electricity-storage module 5.

The voltage converting module 4 is electrically connected to the touch identification module 21, the feedback module 22 and/or the pressure sensing module 23. When the user press the touch region 2 of the surface of the terminal body 1, the touch identification module 21, the feedback module 22 and the pressure sensing module 23 all generate alternating voltages.

A normal working direct voltage of the mobile terminal has an amplitude within a predetermined range, so the alternating voltages are converted into direct voltages having amplitudes within the predetermined range. The direct voltages are stored into the electricity-storage module 5, and when a battery of the mobile terminal is out of power, the electricity-storage module 5 may serve as an emergency power supplier.

Optionally, the touch region 2 may be located at a lateral side or a back of the terminal body 1, such that the touch region does not occupy any area of a front of mobile terminal; therefore, the display screen may be provided with a relatively large display area. The lateral side or the back of the terminal body where the touch region 2 is located is an integral structure, and therefore, no physical button protruding from the surface of the terminal body 1 is necessary, thereby making the appearance of the mobile terminal more nice-looking.

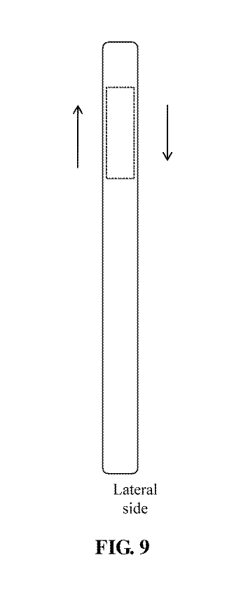

Referring to FIG. 9, in the case that the touch region 2 is at the lateral side of the mobile terminal, the touch region 2 is strip-like, and the user may easily perform the gesture operation.

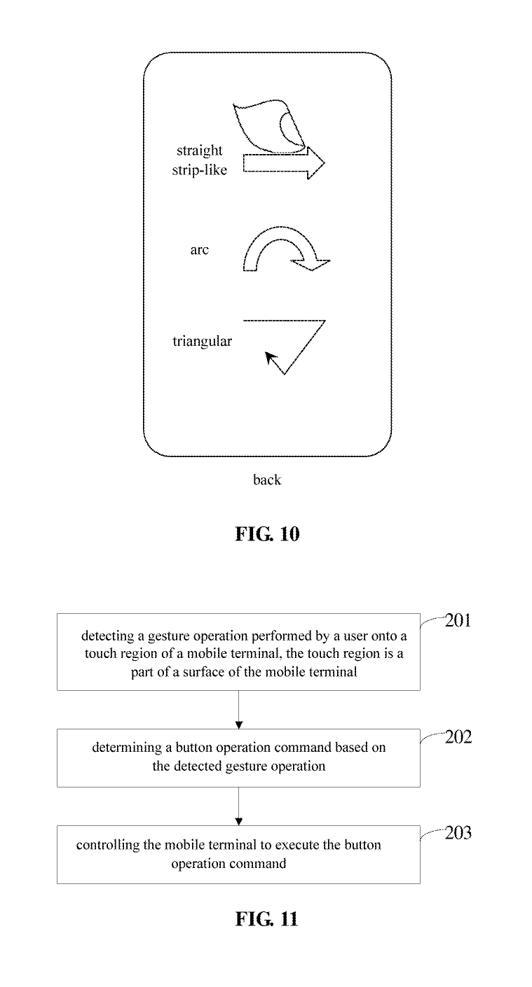

Referring to FIG. 10, in the case that the touch region 2 is at the back of the mobile terminal, the touch region 2 may be straight strip-like, arc, triangular, or the like.

According to the embodiments of the present disclosure, the touch mechanism is arranged in the space extending into the terminal body 1 from the surface thereof, it is able to detect the gesture operation of the user performed onto the touch region 2, and the control module may determine the button operation command based on the gesture operation and control the terminal body 1 to execute the button operation command; therefore, physical buttons protruding from the surface of the terminal body 1 can be replaced by the touch mechanism, which makes the appearance of the mobile terminal more nice-looking.

Referring to FIG. 11, the present disclosure provides in some embodiments a method for controlling a mobile terminal, where the mobile terminal may be any of the mobile terminals according to the embodiments hereinabove. The method includes

step S201, detecting a gesture operation performed by a finger of a user onto a touch region of the mobile terminal;

step S202, determining a button operation command based on the detected gesture operation; and

step S203, controlling the mobile terminal to execute the button operation command.

Optionally, step S202 may include:

acquiring a current status of the mobile terminal, and determining the button operation command based on the detected gesture operation and the acquired current status of the mobile terminal; or

determining the finger with which the user touches the touch region, and determining the button operation command based on the determined finger and the detected gesture operation.

Optionally, the step of determining the button operation command based on the detected gesture operation and the current status of the mobile terminal may include:

determining that the button operation command is a power off command in the case that the current status of the mobile terminal is a power-on operating status and the detected gesture operation is a predetermined first gesture operation, or determining that the button operation command is a screen locking command in the case that the current status of the mobile terminal is the power-on operating status and the detected gesture operation is a predetermined second gesture operation, where the predetermined first gesture operation is different from the predetermined second gesture operation; and

determining that the button operation command is a power on command in the case that the current status of the mobile terminal is a power-off status and the detected gesture operation is a predetermined third gesture operation.

Furthermore, the method further include: acquiring a first fingerprint of the finger of the user;

correspondingly, step S203 may include:

comparing the first fingerprint with second fingerprints in a predetermined fingerprint set in the case that the button operation command is determined to be the power on command; and

controlling the mobile terminal to execute the power on command in the case that the predetermined fingerprint set includes one second fingerprint which is identical to the first fingerprint.

Optionally, subsequent to step S201, the method further includes: controlling a feedback module that is arranged at the touch region to shake.

Optionally, prior to step S201, the method further includes:

acquiring a pressure applied onto the touch region by the finger of the user;

determining a power of the feedback module based on the acquired pressure; and

controlling the feedback module to shake based on the determined power.

According to the embodiments of the present disclosure, the touch mechanism is arranged in the space extending into the terminal body 1 from the surface thereof, it is able to detect the gesture operation of the user performed onto the touch region, and the control module may determine the button operation command based on the gesture operation and control the terminal body to execute the button operation command; therefore, physical buttons protruding from the surface of the terminal body can be replaced by the touch mechanism, thereby making the appearance of the mobile terminal more nice-looking.

The above are merely preferred embodiments of the present disclosure. A person skilled in the art may make further modifications, equivalent replacements and improvements without departing from the principle of the present disclosure, and these replacements and improvements shall also fall within the scope of the present disclosure.

1. A mobile terminal, comprising:
a terminal body, a control module and a touch mechanism, wherein
a surface of the terminal body comprises a touch region, the touch mechanism is arranged in a space extending into the terminal body from the surface of the terminal body, and a perpendicular projection of the touch mechanism onto the surface of the terminal body is within the touch region;
the touch mechanism comprises a touch identification module configured to detect a gesture operation performed by a user onto the touch region; and
the control module is configured to determine a button operation command based on the gesture operation detected by the touch identification module and control the terminal body to execute the button operation command.

2. The mobile terminal according to claim 1, wherein
the control module is configured to acquire a current status of the terminal body, and determine the button operation command based on the gesture operation detected by the touch identification module and the current status of the terminal body; or
the control module is configured to determine a finger with which the user touches the touch region of the surface of the terminal body, and determine the button operation command based on the determined finger and the gesture operation detected by the touch identification module.

3. The mobile terminal according to claim 2, wherein
the control module is configured to determine that the button operation command is a power off command in the case that the current status of the terminal body is a power-on operating status and the gesture operation is a predetermined first gesture operation, or determine that the button operation command is a screen locking command in the case that the current status of the terminal body is the power-on operating status and the gesture operation is a predetermined second gesture operation, wherein the predetermined first gesture operation is different from the predetermined second gesture operation; and
the control module is configured to determine that the button operation command is a power on command in the case that the current status of the terminal body is a power-off status and the gesture operation is a predetermined third gesture operation.

4. The mobile terminal according to claim 3, wherein
the touch identification module is further configured to acquire a first fingerprint of the finger of the user;
the control module is further configured to compare the first fingerprint with second fingerprints in a predetermined fingerprint set in the case that the button operation command is the power on command, and control the terminal body to execute the power on command in the case that the predetermined fingerprint set comprises one second fingerprint which is identical to the first fingerprint.

5. The mobile terminal according to claim 1, wherein
a color of the touch region of the surface of the terminal body is identical to a color of the surface of the terminal body at regions adjacent to the touch region.

6. The mobile terminal according to claim 1, wherein
the touch mechanism further comprises a feedback module; and
the control module is further configured to control the feedback module to shake in the case that the touch identification module detects that a finger of the user touches the touch region.

7. The mobile terminal according to claim 6, wherein
the touch mechanism further comprises a pressure sensing module configured to acquire a pressure applied onto the touch region by the finger of the user; and
the control module is further configured to determine a power of the feedback module based on the pressure acquired by the pressure sensing module and control the feedback module to shake based on the power.

8. The mobile terminal according to claim 6, wherein
the touch identification module is arranged at an outermost layer of the touch mechanism, and a perpendicular projection of the touch identification module onto the surface of the terminal body coincides with the entire touch region.

9. The mobile terminal according to claim 1, further comprising a voltage converting module and an electricity-storage module, wherein
the voltage converting module is configured to receive alternating voltages generated by functional modules at the touch region when the finger of the user touches the touch region, convert the alternating voltages into direct voltages having amplitudes within a predetermined range, and store the direct voltages into the electricity-storage module.

10. The mobile terminal according to claim 1, wherein the touch region is located at a lateral side or a back of the terminal body.

11. The mobile terminal according to claim 10, wherein the touch region is located at the lateral side of the terminal body and is strip-like; or
the touch region is located at the back of the terminal body and is straight strip-like, arc or triangular.

12. A method for controlling a mobile terminal, comprising steps of:
detecting a gesture operation performed by a finger of a user onto a touch region of the mobile terminal;
determining a button operation command based on the detected gesture operation; and
controlling the mobile terminal to execute the button operation command.

13. The method according to claim 12, wherein the step of determining the button operation command based on the detected gesture operation comprises:
acquiring a current status of the mobile terminal, and determining the button operation command based on the detected gesture operation and the acquired current status of the mobile terminal; or
determining the finger with which the user touches the touch region, and determining the button operation command based on the determined finger and the detected gesture operation.

14. The method according to claim 13, wherein the step of determining the button operation command based on the detected gesture operation and the acquired current status of the mobile terminal comprises:
determining that the button operation command is a power off command in the case that the current status of the mobile terminal is a power-on operating status and the detected gesture operation is a predetermined first gesture operation, or determining that the button operation command is a screen locking command in the case that the current status of the mobile terminal is the power-on operating status and the detected gesture operation is a predetermined second gesture operation, wherein the predetermined first gesture operation is different from the predetermined second gesture operation; and
determining that the button operation command is a power on command in the case that the current status of the mobile terminal is a power-off status and the detected gesture operation is a predetermined third gesture operation.

15. The method according to claim 14, further comprising:
acquiring a first fingerprint of the finger of the user;
wherein the step of controlling the mobile terminal to execute the button operation command comprises:
comparing the first fingerprint with second fingerprints in a predetermined fingerprint set in the case that the button operation command is determined to be the power on command; and
controlling the mobile terminal to execute the power on command in the case that the predetermined fingerprint set comprises one second fingerprint which is identical to the first fingerprint.

16. The method according to claim 12, wherein subsequent to the step of detecting the gesture operation performed by the finger of the user onto the touch region of the mobile terminal, the method further comprises:
controlling a feedback module arranged at the touch region to shake.

17. The method according to claim 16, wherein prior to the step of detecting the gesture operation performed by the finger of the user onto the touch region of the mobile terminal, the method further comprises:
acquiring a pressure applied onto the touch region by the finger of the user;
determining a power of the feedback module based on the acquired pressure; and
controlling the feedback module to shake based on the determined power.
